(19) United States
(12) Patent Application Publication
(10) Pub. No.: US 2026/0064806 A1
(43) Pub. Date: Mar. 5, 2026

(54) ENCRYPTION DEVICE AND METHOD

(71) Applicant: Infineon Technologies AG, Neubiberg (DE)

(72) Inventors: Lukas Holzbaur, Muenchen (DE); Mohamed Abdelmonem, Eggenstein-Leopoldshafen (DE); Alexander Zeh, Muenchen (DE)

(21) Appl. No.: 19/305,043

(22) Filed: Aug. 20, 2025

(30) Foreign Application Priority Data
Sep. 4, 2024 (DE) 102024208404.2

(51) Int. Cl. G06F 17/16; G06F 11/07; G06F 17/14

(52) U.S. Cl. CPC G06F 17/16; G06F 11/0751; G06F 17/144

(57) ABSTRACT

Encryption techniques are disclosed that implement a transformation network having at least two stages of butterfly operations, wherein the transformation network is designed to carry out a discrete Fourier transform over rings of multiple input signals to obtain multiple output signals. An error detection device is also described that is designed to obtain at least one subset of the multiple input signals and at least one subset of the multiple output signals of the transformation network and to carry out an error analysis. The error analysis is based on a comparison of a first linear combination of the subset of the multiple input signals to a second linear combination of the subset of the multiple output signals.

### CROSS-REFERENCE TO RELATED APPLICATIONS

The present application claims priority to and the benefit of Germany patent application no. DE 102024208404.2, filed on Sep. 4, 2024, the contents of which are incorporated herein by reference in their entirety.

### TECHNICAL FIELD

Exemplary embodiments of the present disclosure relate to a device and a method for encryption as well as a corresponding data carrier and a computer program. Further exemplary embodiments refer to a device, a method, or a computer program for determining weights.

### BACKGROUND

In modern security concepts, so-called public key cryptography (PKC, asymmetric cryptography) is often used. Typical fields of application include automotive applications, such as key exchange or software update verification. Current PKC algorithms, such as Rivest-Shamir-Adleman encryption or Elliptical Curve Encryption (ECC), no longer meet the appropriate security requirements for quantum computers. Encryption variants that meet the increased requirements are called PQC (post-quantum cryptography). There are different variants here that achieve a good compromise between performance, key size, and safety requirements. One of the most computer-technically complex operations in these areas is the so-called number-theoretic transform (NTT) or discrete Fourier transform via (commutative or algebraic) rings. This NTT is available as both normal NTT and inverse NTT, making it a typical candidate for hardware acceleration (HW). NTT or inverse NTT is a mathematical transformation and is often implemented by splitting it into a plurality of stages, with each stage having multiple butterfly operations.

Error injection is a typical approach of attackers to analyze security systems. In order to identify attacks of this type, error detection is used in encryption approaches. Many applications, such as automotive applications, also require error detection.

### BRIEF DESCRIPTION OF THE DRAWINGS/FIGURES

The accompanying drawings, which are incorporated herein and form a part of the specification, illustrate the aspects of the present disclosure and, together with the description, further serve to explain the principles of the aspects and to enable a person skilled in the pertinent art to make and use the aspects.

Exemplary embodiments of the present disclosure are explained below with reference to the accompanying drawings. In the drawings:

FIG. 1 shows an exemplary block diagram of a transformation network to explain the underlying transformation;

FIG. 2 shows a schematic block diagram to illustrate a butterfly operation;

FIG. 3 shows a schematic block diagram of a transformation network in combination with an error detection device according to exemplary embodiments;

FIG. 4 shows a schematic flowchart for error detection;

FIG. 5 shows a schematic block diagram of a device with transformation network and error detection device for individual error identification according to exemplary embodiments;

FIG. 6 shows a schematic block diagram of a device with transformation network and an error detection device for double error identification according to further exemplary embodiments; and

FIG. 7 shows a schematic block diagram of a device with a divided transformation network and error identification device according to exemplary embodiments.

The example aspects of the present disclosure will be described with reference to the accompanying drawings. The drawing in which an element first appears is typically indicated by the leftmost digit(s) in the corresponding reference number.

### SUMMARY

The object of the present disclosure is to provide a concept for error detection in encryptions, which has an improved compromise between efficiency and reliability.

This object is achieved by means of the subject matter of the various embodiments as discussed herein, including the claims.

Exemplary embodiments of the present disclosure provide a device for encryption having a transformation network and an error detection device. The transformation network has at least two stages of butterfly operations and is designed to carry out a discrete Fourier transform via, for example, commutative or algebraic rings of multiple input signals to obtain multiple output signals. The error detection device is designed to obtain at least one subset of the multiple input signals and at least one subset of the multiple output signals of the transformation network and to carry out an error analysis, wherein the error analysis is based on a comparison of a first linear combination of the subset of the multiple input signals to a second linear combination of the subset of the multiple output signals.

A further exemplary embodiment provides a data carrier comprising a first and a second software component. The first software component is designed to implement a transformation network having at least two stages of butterfly operations, wherein the transformation network is designed to carry out a discrete Fourier transform via rings of multiple input signals to obtain multiple output signals. The second software component is designed to implement an error detection device, which is designed to obtain at least one subset of the multiple input signals and at least one subset of the multiple output signals of the transformation network and to carry out an error analysis. The error analysis is based on a comparison of a first linear combination of the subset of multiple input signals to a second linear combination of the subset of multiple output signals.

A further exemplary embodiment provides a method for encryption comprising the steps:
carrying out a transformation of multiple input signals using a transformation network having at least two stages of butterfly operations to obtain multiple output signals;
The error detection device is designed to obtain at least a subset of the multiple input signals and at least a subset of the multiple output signals of the transformation network and to carry out an error analysis, wherein the error analysis is based on a comparison of a first linear combination of the subset of the multiple input signals to a second linear combination of the subset of the multiple output signals.

A further exemplary embodiment provides a device for determining first weights and second weights as a function of a transformation network that has at least two stages of butterfly operations and is designed to carry out a discrete Fourier transform via rings of multiple input signals, so as to obtain at least multiple output signals,
wherein, using the first weights, a first linear combination of the subset of the multiple input signals can be calculated, and wherein, using the second weights, a second linear combination of the subset of the multiple output signals can be calculated,
wherein the first and second weights are determined such that a calculated value of the first linear combination equals a calculated value of the second linear combination if the encryption has been carried out without error.

A further exemplary embodiment provides a device for determining first weights and second weights as a function of a transformation network that has at least two stages of butterfly operations and is designed to carry out a discrete Fourier transform via rings of multiple input signals, so as to obtain at least multiple output signals,
wherein, using the first weights, a first linear combination of the subset of the multiple input signals can be calculated, and wherein, using the second weights, a second linear combination of the subset of the multiple output signals can be calculated,
wherein the first and second weights are determined such that a calculated value of the first linear combination equals a calculated value of the second linear combination if the encryption has been carried out without error.

A further exemplary embodiment provides a computer program for carrying out the above-described methods.

### DETAILED DESCRIPTION

Before the following exemplary embodiments of the present disclosure are explained with reference to the accompanying drawings, it should be noted that the identically acting elements and structures are provided with identical reference numerals, and therefore the description thereof is applicable to one another or interchangeable.

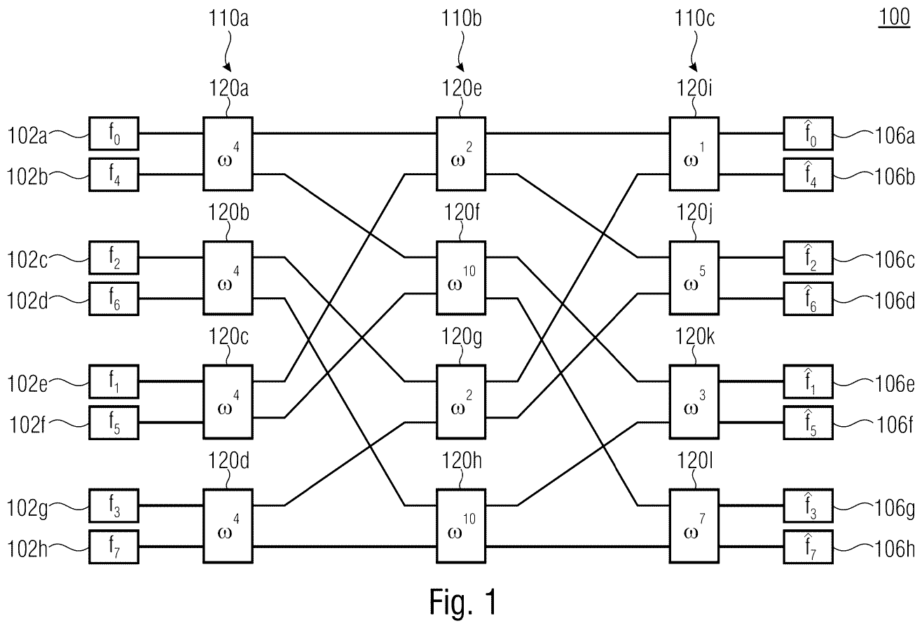

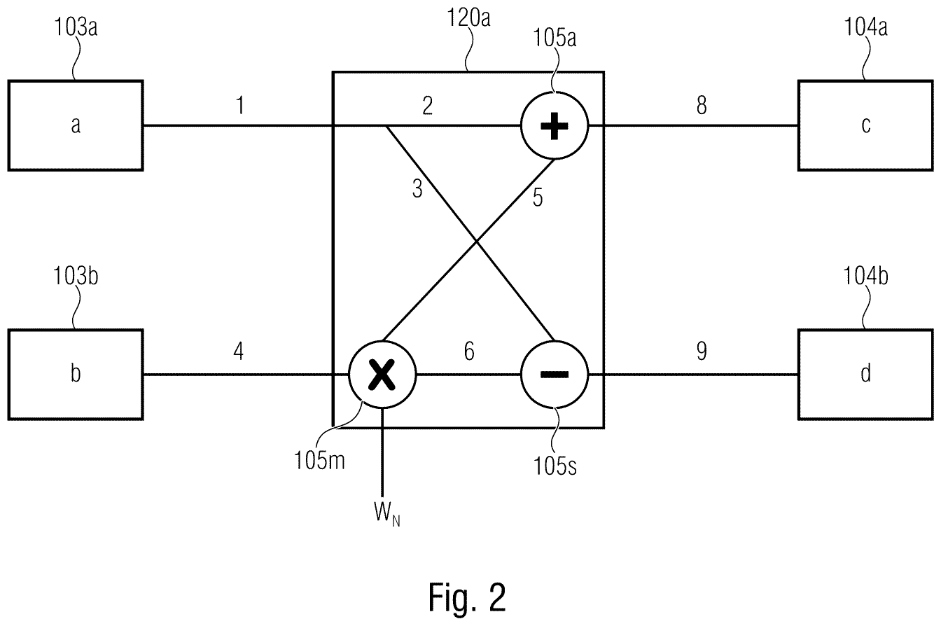

Before exemplary embodiments of the present disclosure are explained, transformation networks with butterfly operations as well as butterfly operations with reference to FIGS. 1 and 2 are explained by way of example.

FIG. 1 shows an NTT network or generally a transformation network 100 with three stages 110a-110c. The transformation network has eight inputs 102a-102h on the input side to the three stages 110a-110c and eight outputs 106a-106h on the output side. Each of the stages has so-called butterfly operations 120a-1201. The butterfly operations 120a-120d belong to the first stage 110a, the butterfly operations 120e-120h to the second stage 110b and the butterfly operations 120i-1201 to the third stage 110c. It should be noted that the transformation network may also have only two or more than three stages 110a and 110c with significantly fewer or more butterfly operations, e.g. two butterfly operations for each stage. On the basis of this, the number of inputs and the number of outputs will of course also be reduced. For example, there are usually 8 stages with N=256 inputs. Background information. In the focus of the exemplary embodiments are “complete” NTTs, i.e. log₂ (N) stages, wherein N is the number of inputs. Typical values are N=256 or N=1024, wherein the actual function is also given for other values of N (powers of 2, but this is always given with NTT) as described.

Each butterfly operation 120a has two inputs 103a and 103b as well as two outputs 104a and 104b (see FIG. 2). With reference to FIG. 2, the element 120a is explained by way of example, wherein the explanation is transferable to all elements 120b-120l.

The first stage 110a has butterfly operands 120a-120d, each connected to two inputs 102a/b, 102c/d, . . . and on the output side to two butterfly operands 120e-120h of the second stage 110b. The butterfly operands 120i-120l of the third stage 110c are connected on the output side to two outputs 106a/b, 106c/d, . . . and on the input side in each case to two butterfly operands 120e-120h of the second stage 110b. Conversely, this means that there is always cross-linking between stages 110a and 110b and between stages 110b and 110c. For example, the butterfly operand 120e is connected to 120a and 120c on the input side and to 120i and 120j on the output side. The butterfly operand 120f is connected to 120a and 120c on the input side and to 120k and 120l on the output side. Thus, the operands 120e and 120f have the same connections on the input side, wherein these are each arranged with other outputs of the preceding butterfly operands 120a and 120c of the first stage 110a. For the sake of completeness, it should also be noted that 120g is connected to 120b and 120d on the input side and 120i and 120j on the output side, while 120h on the input side is linked to 120b and 120d on the input side and 120k and 120l on the output side. This link is shown here by way of example, i.e. it can also vary both on the input side and on the output side and varies especially if more butterfly operands or fewer butterfly operands are provided for each stage 110a-110c or if more stages were available. In general, the transformation networks considered here, e.g. NTTs or inverse NTTs, have in common that a multiplicity of stages 110a-110c are provided, wherein each stage has a fixed number of butterfly operations 120a-120l.

Each butterfly operation correspondingly has exemplary embodiments, thus the inputs 103a and 103b as well as the outputs 104a and 104b. For example, 103a can be linked to 102a and 103b to 102b. For example, 104a can be linked to the butterfly operand 120e, while 104b is connected to the butterfly operand 120f. Each butterfly operand (butterfly block) has an internal interconnection, and therefore each input 103a, 103b can be linked to a mathematical operation on each output 104a and 104b. Multiplications 105m, additions 105a and subtractions 105s are typically provided as the mathematical operation. The butterfly operations are typically executed sequentially, wherein intermediate results are stored or loaded from a corresponding memory (not depicted).

Any path in this network or the butterfly operands thereof can fail, either due to random HW errors or error injection by malicious attackers. The prior art for recording these errors consists in recalculating the arithmetic operations in the butterfly operations. These schemes are referred to below as recalculation schemes. For better coverage of different types of errors, some modifications such as negating input signals and rearranging coefficients so as to modify the paths through the butterfly unit are also considered.

Different variations of this strategy were published by Sarker et al.^{[3]} Although this strategy identifies some errors, it has two major drawbacks. First, the same can only locate errors that occur in the butterfly operand. If a coefficient is loaded incorrectly due to corruption in the memory while reading or writing the previous result, these schemes cannot record these errors. Secondly, since all arithmetic operations are carried out twice, the same cause a significantly increased computational outlay, which is reflected in increased computational time and/or computational range, as well as a high dynamic power consumption. In addition, this increased outlay scales linearly with the number of butterflies that are calculated in the network. There is therefore a need for an improved approach.

Exemplary embodiments of the present disclosure provide a device for encryption 300 with a transformation network 100, e.g. an NTT or inverse NTT, which has a plurality of inputs 102a-102n or a plurality of outputs 106a-106n. In addition, the device 300 has an error detection device 310. This error detection device 310 is arranged parallel to the transformation network 100 and receives as input signals both the input signals f₀-f₇ of the inputs 102a-102n and the output signals \hat{f}₀-\hat{f}₇ of the outputs 106a-106n.

The transformation network 100 can be configured like the transformation network from FIG. 1 with the butterfly operations from FIG. 2, or can also have at least two stages of butterfly operations in the minimum configuration. The transformation network 100 is designed to carry out a discrete Fourier transform over, for example, algebraic rings of multiple input signals f₀-f₇ of the inputs 102a-102n, in order to output multiple output signals \hat{f}₀-\hat{f}₇ of the outputs 106a-106n. According to exemplary embodiments, the transformation network 100 can be part of an encryption device, such as a so-called post-quantum encryption device.

The error detection device 310 is designed to obtain at least a subset of the multiple input signals f₀-f₇ of the inputs 102a-102n and at least a subset of the multiple output signals \hat{f}₀-\hat{f}₇ of the outputs 106a-106n, in order to carry out an error analysis. The error analysis comprises a comparison of a first linear combination of the subset of the multiple input signals f₀-f₇ of the inputs 102a-102n to a second linear combination of the subset of the multiple output signals \hat{f}₀-\hat{f}₇ of the outputs 106a-106n. For example, a checksum can be determined for input signals f₀-f₇ of inputs 102a-102n and also for output signals \hat{f}₀-\hat{f}₇ of outputs 106a-106n. This checksum can be identical according to exemplary embodiments if no error has occurred. In an embodiment, the checksum is not formed as a simple sum, even if this would of course be possible, but as a weight to the sum. This therefore means that each input signal f₀-f₇ of inputs 102a-102n or output signals \hat{f}₀-\hat{f}₇ of outputs 106a-106n is weighted with a corresponding weight.

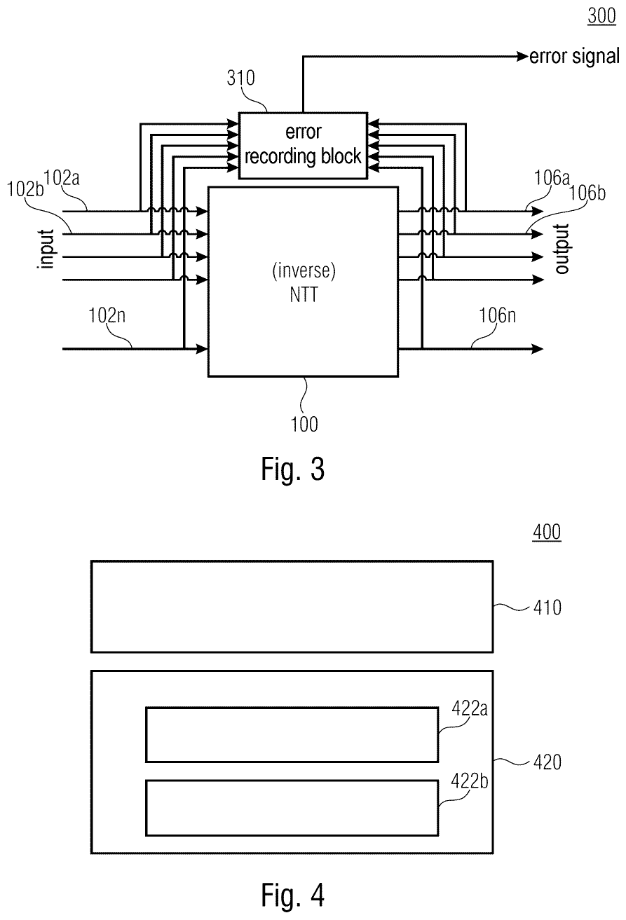

In other words, FIG. 3 shows the functional structure of such an error recording scheme at a high level. The error recording block 310 receives the input signals f₀-f₇ and output signal \hat{f}₀-\hat{f}₇, the NTT/transformation network 100 as inputs and, using weights a₀-a₇ or b₀-b₇ of these, determines the presence of errors that occur in the entire (inverse) NTT calculation. This is in contrast to the recalculation schemes, where errors are recorded at the level of individual butterfly operations.

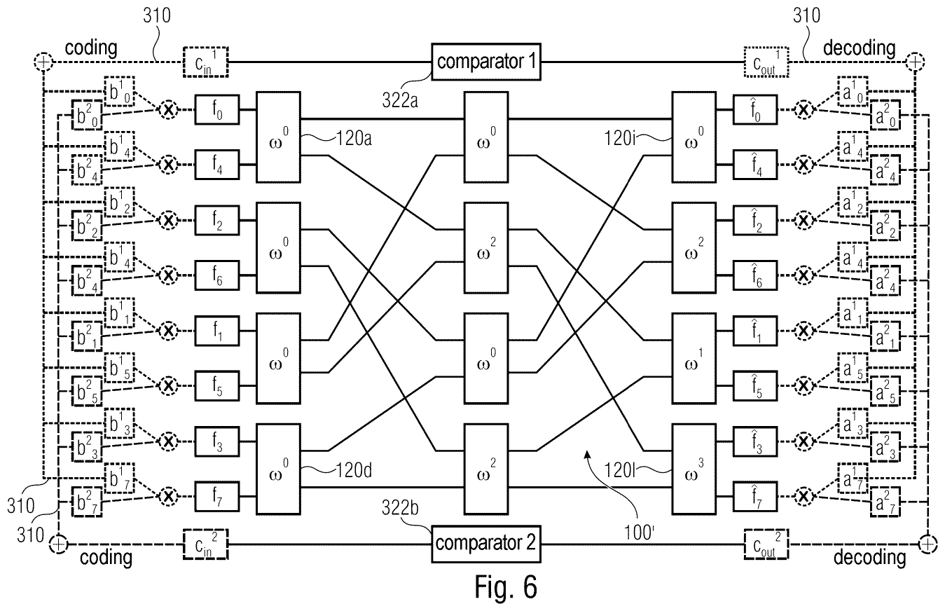

For the sake of completeness, it should be noted that in order to identify an error, the calculated values/checksums differ if an error has occurred. For the selected weights, this is guaranteed for a single error and is very likely for multiple random errors. According to exemplary embodiments, multiple first and second weighting vectors, e.g. with different weights, can be used to identify double errors, as will be explained in connection with FIG. 6.

According to exemplary embodiments, the straight inputs f₀, f₄, f₂ and f₆ can be processed by the elements 120a and 120b, while the odd inputs f₁, f₅, f₃ and f₇ are processed by the elements 120c and 120d. The same nomenclature is used on the output side, and therefore the following sequence of output signals is output by the elements 120i, 120j, 120k and 120l: \hat{f}₀, \hat{f}₄, \hat{f}₂, \hat{f}₆, \hat{f}₁, \hat{f}₅, \hat{f}₃ and \hat{f}₇. According to exemplary embodiments, of course, another arrangement or a different arrangement is possible. According to further exemplary embodiments, elements 120a to 120l can also be interconnected differently.

The weights for the input signals are called first weights, while the weights for the output signals are called second weights. According to exemplary embodiments, the weights are selected in such a way that the condition of the same results of the first and second linear combination is fulfilled, in the event that no error is present. For this purpose, the first and second weights depend on the transformation network and can be determined in advance. For example, the first and second weights belonging to the transformation network are stored in a memory of the device. This means that according to exemplary embodiments, the device has a memory in which the first and second weights for the transformation network to be applied are present. According to exemplary embodiments, the transformation network can be implemented in software, i.e. the weights belonging to a software component in which the transformation network is implemented are stored.

In other words, this means that both unit 100 and unit 310 can be present as a software component. The calculation of linear combinations or checksums in unit 310 is based on multiplication and addition. These mathematical operands are also present in the respective butterfly cell 120a-1201. This allows the transformation network itself to carry out the calculation of the first and second linear combination, thus comprising the task of unit 310.

One exemplary embodiment therefore provides a data carrier comprising a first and second software component. The first and/or second software component can be run on a corresponding processor or both can be run on the same processor. The first software component is designed to implement a transformation network having at least two stages of butterfly operations, wherein the transformation network is designed to carry out a discrete Fourier transform over rings of multiple input signals to obtain multiple output signals. The second software component is designed to implement an error detection device which is designed to obtain at least one subset of the multiple input signals and at least one subset of the multiple output signals of the transformation network, in order to carry out an error analysis, wherein the error analysis is based on a comparison of a first linear combination of the subset of the multiple input signals to a second linear combination of the subset of the multiple output signals.

A further exemplary embodiment provides a method for encryption, as shown in FIG. 4. The method 400 consists of two central steps 410 and 420. A discrete Fourier transform over rings of multiple input signals using a transformation network with two or more stages of butterfly operations is carried out in step 410, in order to obtain multiple output signals. In the second step 420, at least one subset of the multiple input signals and at least one subset of the multiple output signals of the transformation network (cf. 422) is obtained and an error analysis 424 is carried out. The error analysis is based on a comparison of a first linear combination of the subset of multiple input signals to a second linear combination of the subset of multiple output signals. In other words, the proposed error recording scheme functions by calculating weighted sums of the input signals (in terms of values of the input signals or of input values) or output signals (in terms of values of the output signals) of the (inverse) NTT.

According to exemplary embodiments, a method is therefore described for recording errors in the calculation of transformations, such as (inverse) NTT, which are not based on recalculation, but instead exploit the mathematical structure inherent in the NTT. Methods for a guaranteed correction of single errors and double errors and the application of the same principles in incomplete NTT will be described in more detail.

This method can be computer-implemented according to further exemplary embodiments. In this respect, a computer program is created for carrying out the method or the method steps 410, 420, 422 and 424, if the method 400 runs on a processor.

At this point, it should be noted that the first weights can be defined by a first weighting vector a and the second weights can be defined by a second weighting vector b. The two weighting vectors a and b are based on the formula b=a·A, wherein A represents a matrix representing the behavior or inverse behavior of the transformation network 100.

The following is a detailed technical description in the case of a negatively enveloped convolution-based NTT. This is the most relevant case for cryptographic applications. This is followed by a more abstract definition that covers the different variations of the NTT and the inverse NTT.

Since the error correction scheme considered in this disclosure may function using the input signals and output signals of the (inverse) NTT, the implementation units of the (inverse) NTT block are abstracted below. Instead, only the linear transformation, which can be described by an N×N matrix A, is taken into account, where the output signals f refer to the input signals f, by \hat{f}=A·f.

By defining the negatively enveloped convolution-based NTT, matrix A is given by

$$A = ( \begin{matrix}{ω}_{2 N}^{0} & {ω}_{2 N}^{( 2 \cdot 0 + 1 ) \cdot 1} & … & {ω}_{2 N}^{( 2 \cdot 0 + 1 ) \cdot ( N - 1 )} \\ {ω}_{2 N}^{0} & {ω}_{2 N}^{( 2 \cdot 1 + 1 ) \cdot 1} & … & {ω}_{2 N}^{( 2 \cdot 1 + 1 ) \cdot ( N - 1 )} \\ ⋮ & ⋮ & ⋱ & ⋮ \\ {ω}_{2 N}^{0} & {ω}_{2 N}^{( 2 \cdot ( N - 1 ) + 1 ) \cdot 1} & … & {ω}_{2 N}^{( 2 \cdot ( N - 1 ) + 1 ) \cdot ( N - 1 )}\end{matrix} ) ,$$

wherein ω_{2N} is the 2N-th primitive unit root. The inverse NTT is defined as the mathematical inverse of this matrix.

In this respect, a further exemplary embodiment provides a calculation concept in order to find the first and second weights or the first weighting vector a and the second weighting vector b. For this purpose, according to exemplary embodiments, a device can be provided, which is designed to determine the first and second weights as a function of the transformation network 100. This device determines the weights under the following two premises:
wherein, using the first weights, a first linear combination of the subset of the multiple input signals can be calculated, and wherein, using the second weights, a second linear combination of the subset of the multiple output signals can be calculated,
wherein the first and second weights are determined such that a calculated value of the first linear combination equals a calculated value of the second linear combination, if the discrete Fourier transform over rings has been carried out without error.

Generally speaking, for all the schemes described, the conditions for the weightings lead to a space for solutions. From this space, it is possible to select weightings that allow efficient implementation. For example, it is possible to set every second weight for the input signals (input values) and the output signals (output values) to be equal to one, that is, one of the inputs/outputs for each of the butterfly operations in the first/last stage. Then, by setting up and solving the linear system of equations b=a·A, a solution is obtained where half of the weightings for the weighted sums are equal to one. This reduces the number of required multiplications from 2N to N.

A further exemplary embodiment provides a corresponding method for determining the first and second weights, also under the conditions:
wherein, using the first weights, a first linear combination of the subset of the multiple input signals can be calculated, and wherein, using the second weights, a second linear combination of the subset of the multiple output signals can be calculated,
wherein the first and second weights are determined such that a calculated value of the first linear combination equals a calculated value of the second linear combination, if the discrete Fourier transform over rings has been carried out without error.

The method can, according to exemplary embodiments, comprise setting up and solving a system of equations, wherein each equation is set up for a possible error position (in the path considered). Thus, the number of equations is determined by the number of butterfly operations in the transformation network or, in general, the transformation network.

Of course, this method can also be computer-implemented. This means that an exemplary embodiment comprises a computer program for carrying out the method or the method steps.

According to exemplary embodiments, the first and second weights are determined depending on the transformation network or in dependence thereon. According to exemplary embodiments, the determination takes place on the basis of the formula b=a·A already introduced above, wherein A represents a matrix that describes the behavior or inverse behavior of the transformation network 100. According to further exemplary embodiments, further conditions can be taken into account, namely wherein the first weights are defined by a first weighting vector a and the second weights are defined by a second weighting vector b, wherein the first weighting vector a and the second weighting vector b are determined on the basis of the formula b=a·A, wherein A represents a matrix that describes the behavior or inverse behavior of the network.

According to one exemplary embodiment, the first weights b₀-b₇ and second weights a₀-a₇ can be determined on the condition that they fulfil the following inequations:

$${S}_{\frac{N}{{2}^{l} {m}_{2} + {n}_{2}}}^{l} ( a ) = {\sum }_{{m}_{1} = 0}^{\frac{N}{{2}^{l}} - 1} {ω}_{2 N}^{( 2 ( {2}^{l} {m}_{1} + {m}_{2} ) + 1 ) {n}_{2}} {a}_{{2}^{l} {m}_{1} + {m}_{2}} \neq 0$$

$$0 \leq l \leq {log}_{2} ( N ) ,$$

$$0 \leq {n}_{2} \leq {2}^{l} - 1 ,$$

$$0 \leq {m}_{2} \leq \frac{N}{{2}^{l}} - 1 ,$$

wherein N indicates the dimension of the transformation network (100), wherein l=0, . . . , log₂ N, for each stage and wherein m₂∈{0, . . . , 2^{l}−1} and

$${n}_{2} ∈ \{ 0 , ... , \frac{N}{{2}^{l}} - 1 \} .$$

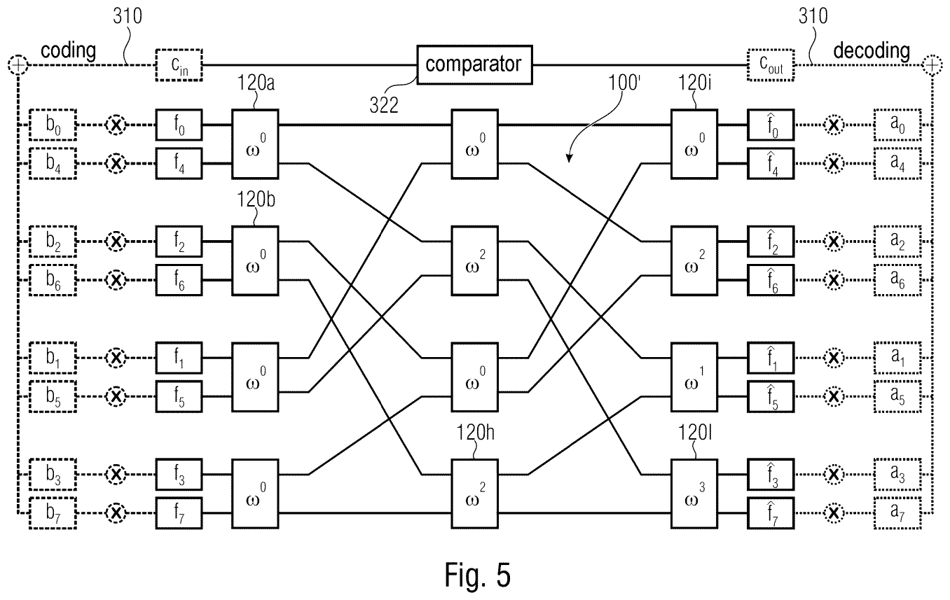

The use of a first weighting vector and of a second weighting vector aims to identify a single error. According to exemplary embodiments, the error detection device can be designed to identify an individual error if a calculated value of the first linear combination deviates from a calculated value of the second linear combination. For this purpose, a comparator (see FIG. 5) is used, for example.

The recording of an individual error is carried out by comparing two weighted sums over the input signals f or output signals \hat{f}. To record a single error, the block calculates

$${C}_{out} = a \cdot \hat{f}$$

$${C}_{in} = b \cdot f .$$

If Cₒᵤₜ==Cᵢₙ, the block concludes that no error has occurred. Otherwise, the block signals an error. The weightings are selected in such a way that b=a·A. This ensures that Cₒᵤₜ==Cᵢₙ if no error has occurred. In order to ensure that each individual error can be recorded during the calculation, the weightings are additionally selected to fulfil the inequations:

$${S}_{\frac{N}{{2}^{l} {m}_{2} + {n}_{2}}}^{l} ( a ) = {\sum }_{{m}_{1} = 0}^{\frac{N}{{2}^{l}} - 1} {ω}_{2 N}^{( 2 ( {2}^{l} {m}_{1} + {m}_{2} ) + 1 ) {n}_{2}} {a}_{{2}^{l} {m}_{1} + {m}_{2}} \neq 0$$

$$0 \leq l \leq {log}_{2} ( N ) ,$$

$$0 \leq {n}_{2} \leq {2}^{l} - 1 ,$$

$$0 \leq {m}_{2} \leq \frac{N}{{2}^{l}} - 1 ,$$

(negatively enveloped convolution-based NTT). The set of these equations is marked by [symbol] .

According to exemplary embodiments, it would also be conceivable that the concept need not be determined for each position when finding the weights, but rather that a simplification can take place by specifying individual weights in advance, for example as zero or as one, in order to simplify the calculation outlay in determining the weights.

FIG. 5 shows an NTT butterfly network 100 together with the unit 310. The unit 310 has a comparator 322, which compares the result cᵢₙ the first linear combination with the result cₒᵤₜ of the second linear combination:
Cᵢₙ is the sum of the input signals f₀-f₇ weighted with the first weights b₀-b₇.
Cₒᵤₜ represents the summed result of the weighted outputs \hat{f}₀-\hat{f}₇ with the second weights a₀a₇.

By selecting the weightings as described above, each individual error in this network is guaranteed to be recorded. This includes errors under a strong-attacker model, in which the error value and the error position are controlled by the attacker.

According to one exemplary embodiment, the weights can also be defined by two first partial weighting vectors and two second partial weighting vectors. In this case, according to exemplary embodiments, the two first and the two second weighting vectors are determined in such a way that the following inequations are fulfilled:

$${S}_{\frac{N}{{2}^{l}} {m}_{2} + {n}_{2}}^{l} ( {a}^{( 1 )} ) \neq 0$$

$${S}_{\frac{N}{{2}^{l}} 2 + {n}_{2}}^{l} ( {a}^{( 2 )} ) \neq 0$$

$${S}_{\frac{N}{{2}^{l}} {m}_{2} + {n}_{2}}^{l} ( {a}^{( ( 2 )} ) {S}_{\frac{N}{{2}^{\tilde{l}}} {\tilde{m}}_{2} + {\tilde{n}}_{2}} ( {a}^{( 1 )} ) - {S}_{\frac{N}{{2}^{l}} {m}_{2} + {n}_{2}}^{l} ( {a}^{( 1 )} ) {S}_{\frac{N}{2} {\tilde{l}}_{\tilde{l}} {\tilde{m}}_{2} + {\tilde{n}}_{2}} ( {a}^{( 2 )} ) \neq 0 ,$$

$$0 \leq l , \tilde{l} \leq {log}_{2} ( N ) ,$$

$$0 \leq {n}_{2} , {\tilde{n}}_{2} \leq {2}^{l} - 1 ,$$

$$0 \leq {m}_{2} , {\tilde{m}}_{2} \leq \frac{N}{{2}^{l}} - 1 ,$$

wherein a triple l, n₂ and m2 is not equal to a triple \tilde{l}, ñ₂ and \tilde{m}₂,
wherein N indicates the dimension of the transformation network, wherein l and \tilde{l}=0, . . . , log₂ N for each stage and wherein \tilde{m}₂ and m₂∈{0, . . . , 2^{l}−1} and ñ₂ and

$${n}_{2} ∈ \{ 0 , ... , \frac{N}{{2}^{l}} - 1 \} .$$

By using the partial weighting vectors, the error detection device is designed to identify a double error if a calculated value of the first linear combination calculated using one of the two first partial weighting vectors deviates from a calculated value of the two second linear combinations calculated using a second of the two partial weighting vectors or if a calculated value of the first linear combination calculated using a further one of the two first two partial weighting vectors deviates from a calculated value of the two second linear combinations calculated using a second one of the two partial weighting vectors.

To record two errors, two weighted sums are calculated both for the values of the input signals and values of the output signal values. As far as can be established, there are no known methods for double error recording based on weighted sums, either for the FFT or for the NTT.

The coefficients of the outputs are denoted by the two vectors a⁽¹⁾ and a⁽²⁾. The coefficients of the inputs are again given by the NTT of the output coefficients. The above-mentioned inequations are fulfilled for error recording in order to be successful for each combination of two errors in the network. The set of these equations is denoted by [symbol] .

FIG. 6 illustrates a double error identification of this type in the NTT network 100. Here, two comparators 122a are present in the error detection device 310′. The two comparators are illustrated with the reference signs 322a and 322b. To calculate the two linear combinations cᵢₙ¹ and cᵢₙ² on the input side, each input signal f₀-f₇ is multiplied by two different weights

$${b}_{0}^{1}$$

-b₇¹ and b₀² and b₇². The same applies to the initial values \hat{f}₀-\hat{f}₇, which are multiplied once by a₀¹-a₇¹ and once by a₀²-a₇². The sum cᵢₙ¹ is calculated from the sum of the input values f₀-f₇ multiplied by b₀¹-b₇¹, while the sum cᵢₙ² is determined using the weights b₀²-b₇². On the output side, cₒᵤₜ¹ is determined on the basis of the output signals \hat{f}₀-\hat{f}₇ weighted by a₀¹-a₇¹ (sum), while cₒᵤₜ² is determined using the weights a₀²-a₇² (sum). By selecting the weightings as described above, each combination of two errors in this network is guaranteed to be recorded. This includes errors under a strong-attacker model, in which the error values and the error positions are controlled by the attacker.

If some of the above-described details are abstracted, the conditions for the weightings for the input signals and output signals, i.e. the inequations [symbol] and [symbol] are derived by evaluating parts of the butterfly network starting from the assumed error position. Each position (or combination of two positions in the case of double error recording) corresponds to such an inequation and therefore condition for the weightings. These concepts are formulated more abstractly below:

An exemplary embodiment provides a method in which errors are recorded by calculating weighted sums of the input signals and output signals of the (inverse) NTT and comparing the results. The weightings are selected in such a way that the same are the (inverse) NTT of one another.

An exemplary embodiment provides a concept for determining the weights based on one or more conditions and/or using inequations:
e.g. the weightings are selected in such a way that the set of inequations [symbol] is fulfilled.
e.g. the weightings can be determined by carrying out a partial transformation.
e.g. the weightings are determined by carrying out parts of the butterfly network.

A further exemplary embodiment provides a method in which two weighted sums are calculated and the weightings are selected in such a way that the set of equations [symbol] is fulfilled.

In one exemplary embodiment, the weightings of the two weighted sums are derived by partial transformations, and therefore the weighted sums of these partial transformations, which are interpreted as vectors, are linearly independent.

In one exemplary embodiment, the weighted sums are calculated on a subset of inputs and outputs corresponding to an incomplete (inverse) NTT.

Advantageously, the weightings are selected in such a way as to allow efficient multiplication.

According to one exemplary embodiment, two half-sized NTTs can be used equivalent to create an error recording scheme.

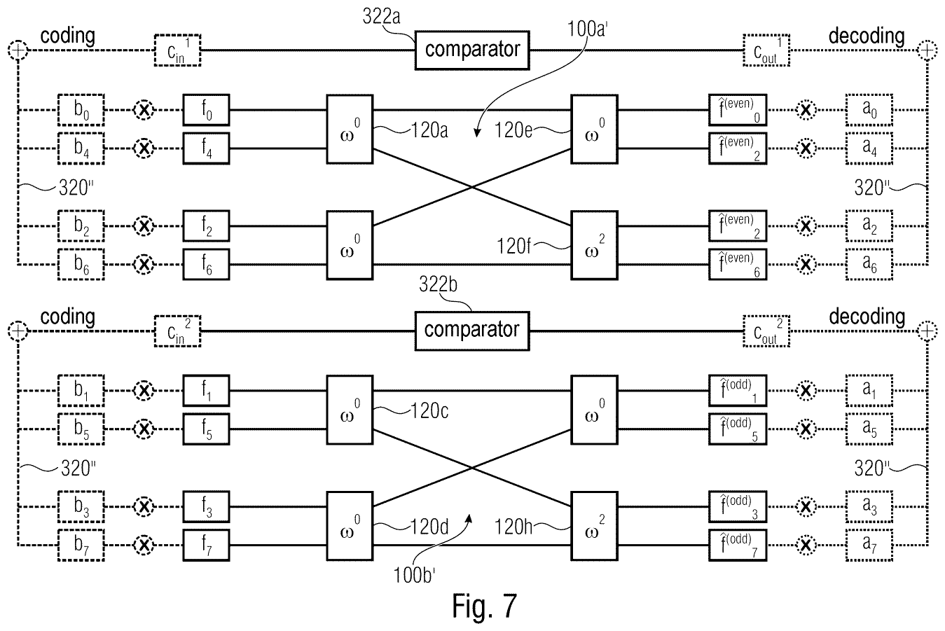

According to one exemplary embodiment, each transformation network can be split into multiple subnetworks. FIG. 7 shows a transformation network 310′ with two transformation network parts 100a′ and 100b′ for illustration of individual error recording schemes for the case of log₂ (N)−1 stages. Here, in the network parts 100a′ and 100b′, two stages are each provided with two butterfly operations, which are marked by the reference signs 120a, 120b, 120e and 120f for the network part 100a′ and by the reference signs 120c and 120d and 120g and 120h for the network part 100b′. 100a′ processes the “even” input signals f₀, f₄, f₂ and f₆ (corresponds to a subset of the multiple input signals) and outputs the even output signals \hat{f}₀, \hat{f}₄, \hat{f}₂ and \hat{f}₆ (corresponds to a subset of the multiple output signals). The network 100b′ processes the “odd” input signals f₁, f₅, f₃ and f₇ (corresponds to a further subset of the multiple input signals) and outputs the “odd” output signals \hat{f}₁, \hat{f}₅, \hat{f}₃ and \hat{f}₇ (corresponds to a subset of the multiple output signals). For each network part 100a′ and 100b′, a separate cᵢₙ value and cₒᵤₜ value of the linear combination is calculated by the error detection device 320″ for each network part 100a′ and 100b′ and compared by the comparators 322a and 322b. For this purpose, partial weighting vectors according to exemplary embodiments are used, wherein the first partial weighting vector has the weights b₀, b₄, b₂ and b₆ and the other first partial weighting vector has the weights b₁, b₅, b₃ and b₇. One second partial weighting vector has the weights a₀, a₄, a₂ and a₆, while the other second partial weighting vector has the weights a₁, a₅, a₃ and a₇. These are used for multiplication with respective inputs f₀-f₇ and respective outputs \hat{f}₀-\hat{f}₇, which are then summed for each network part 100a′ and 100b′ on the input side and on output side.

Some cryptographic schemes use incomplete NTT (also referred to as not fully divided) in their calculations. In this case, the NTT does not consist of the full log₂ (N) stages, but instead stops before the power stage is reached. The same error recording concept as described above can be applied to this type of NTT by dividing same into subsections, which in turn act as smaller NTTs.

For the exemplary embodiment from FIG. 7 it should be noted that, according to exemplary embodiments, the number of butterfly operations for each network part 100a′ and 100b′ can also be different. Of course, multiple network parts can also be provided. By dividing the network into multiple network parts, it is advantageously possible not only to output an error signal, as shown in FIG. 3, which indicates that an error is present, but also to locate the error, at least seen on the network part.

Even if, in the above exemplary embodiment, it is always assumed that negatively enveloped convolution-based NTTs are used, the principle is transferable to all types of transformation networks. For example, a positively enveloped convolution-based NTT or a corresponding inverse thereof can also be used.

For the sake of simplicity, the preceding detailed descriptions are for the negatively enveloped convolution-based NTT. However, the same concepts also apply to positively enveloped convolution-based NTTs and their respective inverse.

Although the functional architecture shown in FIG. 3 recalls an implementation in HW, it should be noted that this is a functional view and multiple implementations are conceivable, including, but not limited to:

Parallel HW: The NTT and error recording are carried out by separate HW blocks, wherein the respective calculations are carried out in parallel (where possible).

Alternative, sequential HW: The NTT and the error recording are carried out by the same HW blocks that carry out the calculations sequentially. This setting covers the general configuration of (inverse) NTT accelerators consisting of some memories, an HW block that implements the butterfly operation, and control logic. In this case, the additional HW outlay would be more complex control logic.

Alternative, HW/SW: A system consisting of a CPU and an HW accelerator for the (inverse) NTT that can be used by the CPU is taken into consideration. The CPU outputs a new NTT calculation to the HW. While the acceleration block is busy, same CPU begins processing the input signals and, upon receiving the results of the acceleration block, it checks whether errors occurred during this calculation by carrying out the remaining operations at the outputs.

Applications for transformation networks explained above are coding applications, such as asymmetric cryptography for example, which are used in many automotive applications. For example, many control devices use encryption functions for key exchange or key exchange protocol or for verifying software updates. In this respect, an exemplary embodiment provides a control unit, e.g. a control unit of a vehicle with a corresponding device for encryption, e.g. based on a post-quantum or asymmetric encryption. Exemplary embodiments of the present disclosure reduce the space and/or time overhead in the calculation of such algorithms by simple realization of error identifications, as is used in some NTTs. It is also advantageous in this regard that this type of error identification also identifies the errors that occur when data is transmitted from one butterfly operation to the next butterfly operation and not only the errors that can happen in the butterfly cell during the calculation. The calculation of the checksum or of the linear combination in general is simple and can be carried out using the same elements that also form the transformation network, e.g. serially, that is to say after the transformation. In this respect, exemplary embodiments of the present disclosure increase reliability and safety.

Although some aspects have been described in connection with a device, it is to be understood that these aspects also constitute a description of the corresponding method, with the result that a block or a structural element of a device should also be understood to be a corresponding method step or as a feature of a method step. Analogously thereto, aspects which have been described in connection with a method step or as a method step also constitute a description of a corresponding block or detail or feature of a corresponding device. Some or all of the method steps can be performed by a hardware apparatus (or using a hardware apparatus), such as a microprocessor, a programmable computer or an electronic circuit. In some exemplary embodiments, some or a plurality of the most important method steps can be performed by such an apparatus.

Depending on certain implementation requirements, exemplary embodiments of the disclosure can be implemented in hardware or in software. The implementation can be carried out using a digital storage medium, for example a floppy disk, a DVD, a Blu-ray disc, a CD, a ROM, a PROM, an EPROM, an EEPROM or a FLASH memory, a hard disk or another magnetic or optical memory, on which electronically readable control signals are stored that can interact or do interact with a programmable computer system in such a way that the respective method is carried out. For this reason, the digital storage medium can be computer-readable.

Some exemplary embodiments according to the disclosure thus comprise a data carrier, which has electronically readable control signals that are capable of interacting with a programmable computer system in such a way that one of the methods described herein is carried out.

In general, exemplary embodiments of the present disclosure can be implemented as a computer program product having a program code, wherein the program code is effective in carrying out one of the methods if the computer program product runs on a computer.

The program code can also be stored, for example, on a machine-readable carrier.

Other exemplary embodiments comprise the computer program for carrying out one of the methods described here, wherein the computer program is stored on a machine-readable carrier. In other words, an exemplary embodiment of the method according to the disclosure is thus a computer program that has a program code for carrying out one of the methods described here if the computer program runs on a computer.

A further exemplary embodiment of the methods according to the disclosure is thus a data carrier (or a digital storage medium or computer-readable medium), on which the computer program for carrying out one of the methods described herein is recorded.

A further exemplary embodiment of the method according to the disclosure is thus a data stream or sequence of signals, which represents or represent the computer program for carrying out one of the methods described herein. The data stream or the sequence of signals can be configured, for example, so as to be transferred via a data communication connection, for example via the Internet.

A further exemplary embodiment comprises a processing device, for example a computer or a programmable logic device, which is configured or adapted for carrying out one of the methods described herein.

A further exemplary embodiment comprises a computer, on which the computer program for carrying out one of the methods described herein is installed.

A further exemplary embodiment according to the disclosure comprises a device or a system, which is designed to transmit a computer program for carrying out at least one of the methods described herein to a receiver. The transmission can be done electronically or optically, for example. The receiver can be, for example, a computer, a mobile device, a storage device or a similar device. The apparatus or the system can comprise, for example, a file server for transmitting the computer program to the receiver.

In some exemplary embodiments, a programmable logic device (for example a field-programmable gate array, FPGA) can be used to perform some or all functionalities of the methods described herein. In some exemplary embodiments, a field-programmable gate array can interact with a microprocessor to carry out one of the methods described herein. In general, the methods in some exemplary embodiments are carried out by any desired hardware apparatus. The latter can be universally usable hardware, such as a computer processor (CPU) or hardware that is specific to the method, such as an ASIC.

The above-described exemplary embodiments are merely an illustration of the principles of the present disclosure. It is to be understood that modifications and variations of the arrangements and details described herein will be obvious to others skilled in the art. For this reason, the disclosure is intended to be limited merely by the scope of protection of the following claims rather than by the specific details which have been presented on the basis of the description and the explanation of the exemplary embodiments herein.

### CONCLUSION

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

It is further to be noted that specific terms used in the description and claims may be interpreted in a very broad sense. For example, the terms “circuit” or “circuitry” used herein are to be interpreted in a sense not only including hardware but also software, firmware or any combinations thereof. The term “data” may be interpreted to include any form of representation data. The term “information” may in addition to any form of digital information also include other forms of representing information. The term “entity” or “unit” may in embodiments include any device, apparatus circuits, hardware, software, firmware, chips, or other semiconductors as well as logical units or physical implementations of protocol layers etc. Furthermore, the terms “coupled” or “connected” may be interpreted in a broad sense not only covering direct but also indirect coupling.

It is further to be noted that methods disclosed in the specification or in the claims may be implemented by a device having means for performing each of the respective steps of these methods.

Although specific embodiments have been illustrated and described herein, it will be appreciated by those of ordinary skill in the art that a variety of alternate and/or equivalent implementations may be substituted for the specific embodiments shown and described without departing from the scope of the present disclosure. This disclosure is intended to cover any adaptations or variations of the specific embodiments discussed herein.

### REFERENCES

The following references are cited throughout this disclosure as applicable to provide additional clarity, e.g. with regards to terminology. These citations are made by way of example and ease of explanation and not by way of limitation.

Citations to the following references are made throughout the application using a matching bracketed number, e.g., [1].
[1] 1 N. I. for Standards and T. (NIST), Post-Quantum Cryptography, Selected Algorithms 2022. https://.csrc.nist.gov/Projects/post-quantum-cryptography/selected-algorithms-2022. [Online], available at: https://csrc.nist.gov/Projects/post-quantum-cryptography/selected-algorithms-2022.
[2] C. A. for Cryptologic Research (CACR), Chinese Post-Quantum Competition. 2020. Accessed: Jun. 29, 2023. [Online], available at: https://www.cacrnet.org.cn/site/content/854.html
[3] A. Sarker, M. Mozaffari-Kermani, and R. Azarderakhsh, “Hardware Constructions for Error Detection of Number-Theoretic Transform Utilized in Secure Cryptographic Architectures,” IEEE Transactions on Very Large Scale Integration (VLSI) Systems, vol. 27, no. 3, pp. 738-741, March 2019, doi: 10.1109/TVLSI.2018.2881097.
[4] A. Sarker, M. M. Kermani, and R. Azarderakhsh, “Error Detection Architectures for Ring Polynomial Multiplication and Modular Reduction of Ring LWE in $\boldsymbol\frac\mathbbZ/p\mathbbZ[x]x\hat{ }n+1$. Benchmarked on ASIC,” IEEE Transactions on Reliability, vol. 70, no. 1, pp. 362-370, March 2021, doi: 10.1109/TR.2020.2991671.
[5] A. Sarker, A. C. Canto, M. M. Kermani, and R. Azarderakhsh, “Error Detection Architectures for Hardware/Software Co-design Approaches of Number-Theoretic Transform,” IEEE Transactions on Computer-Aided Design of Integrated Circuits and Systems, pp. 1-1, 2022, doi: 10.1109/TCAD.2022.3218614.
[6] D. L. Tao and C. R. P. Hartmann, “A novel concurrent error detection scheme for FFT Networks,”. IEEE Transactions on Parallel and Distributed Systems, vol. 4, no. 2, pp. 198-221, February 1993, doi: 10.1109, 71.207595.

What is claimed is:

1. A device for encryption, having the following features:
a transformation network comprising at least two stages of butterfly operations,
wherein the transformation network is configured to carry out a discrete Fourier transform over rings of multiple input signals to obtain multiple output signals; and
an error detection device configured to obtain at least one subset of the multiple input signals and at least one subset of the multiple output signals of the transformation network, and to carry out an error analysis,
wherein the error analysis is based on a comparison of a first linear combination of the subset of the multiple input signals to a second linear combination of the subset of the multiple output signals.

2. The device as claimed in claim 1, wherein the first linear combination is determined using first weights for each input signal, and
wherein the second linear combination is determined using second weights for each output signal.

3. The device as claimed in claim 2, wherein the first weights and the second weights depend on the transformation network, or are determined in advance depending on the transformation network.

4. The device as claimed in claim 2, further comprising:
a memory configured to store the first weights for each input signal and the second weights for each output signal.

5. The device as claimed in claim 2, wherein:
the first weights are defined by a first weighting vector a,
the second weights are defined by a second weighting vector b,
the first weighting vector a and the second weighting vector b are determined on the basis of the formula b=a·A, and
A represents a matrix that describes a behavior or an inverse behavior of the transformation network.

6. The device as claimed in claim 2, wherein:
the first weights and the second weights are determined based upon satisfying the following inequations:
$${S}_{\frac{N}{{2}^{l} {m}_{2} + {n}_{2}}}^{l} ( a ) = {\sum }_{{m}_{1} = 0}^{\frac{N}{{2}^{l}} - 1} {ω}_{2 N}^{( 2 ( {2}^{l} {m}_{1} + {m}_{2} ) + 1 ) {n}_{2}} {a}_{{2}^{l} {m}_{1} + {m}_{2}} \neq 0$$
$$0 \leq l \leq {log}_{2} ( N ) ,$$
$$0 \leq {n}_{2} \leq {2}^{l} - 1 ,$$
$$0 \leq {m}_{2} \leq \frac{N}{{2}^{l}} - 1 ,$$
N indicates a dimension of the transformation network,
l=0, . . . , log₂ N, for each stage of the at least two stages, and
m₂ ∈{0, . . . , 2^{l}−1} and
$${n}_{2} ∈ \{ 0 , ... , \frac{N}{{2}^{l}} - 1 \} .$$

7. The device as claimed in claim 1, wherein the error detection device is configured to identify an individual error in response to a calculated value of the first linear combination of the subset of the multiple input signals deviates from a calculated value of the second linear combination of the subset of the multiple output signals.

8. The device as claimed in claim 2, wherein the first weights are defined by two first partial weighting vectors, and
wherein the second weights are defined by two second partial weighting vectors.

9. The device as claimed in claim 8, wherein:
the weights of the two first partial weighting vectors and the weights of the two second partial weighting vectors are determined that satisfy the following inequations:
$${S}_{\frac{N}{{2}^{l}} {m}_{2} + {n}_{2}}^{l} ( {a}^{( 1 )} ) \neq 0$$
$${S}_{\frac{N}{{2}^{l}} {m}_{2} + {n}_{2}}^{l} ( {a}^{( 2 )} ) \neq 0$$
$${S}_{\frac{N}{{2}^{l}} {m}_{2} + {n}_{2}}^{l} ( {a}^{( ( 2 )} ) {S}_{\frac{N}{{2}^{\tilde{l}}} {\tilde{m}}_{2} + {\tilde{n}}_{2}} ( {a}^{( 1 )} ) - {S}_{\frac{N}{{2}^{l}} {m}_{2} + {n}_{2}}^{l} ( {a}^{( 1 )} ) {S}_{\frac{N}{{2}^{l}} {\tilde{m}}_{2} + {\tilde{n}}_{2}} ( {a}^{( 2 )} ) \neq 0 ,$$
$$0 \leq l , \tilde{l} \leq {log}_{2} ( N ) ,$$
$$0 \leq {n}_{2} , {\tilde{n}}_{2} \leq {2}^{l} - 1 ,$$
$$0 \leq {m}_{2} , {\tilde{m}}_{2} \leq \frac{N}{{2}^{l}} - 1$$
a triple l, n₂ and m2 is not equal to a triple \tilde{l}, ñ₂ and \tilde{m}₂,
N indicates the dimension of the transformation network,
l and \tilde{l}=0, . . . , log₂ N for each stage, and
\tilde{m}₂ and m₂∈{0, . . . , 2^{l}−1} and ñ₂ and
$${n}_{2} ∈ \{ 0 , ... , \frac{N}{{2}^{l}} - 1 \} .$$

10. The device as claimed in claim 8, wherein the error detection device is configured to identify a double error in response to (i) a calculated value of the first linear combination calculated using one of the two first partial weighting vectors deviating from a calculated value of the second linear combination calculated using one of the two second partial weighting vectors, or (ii) a calculated value of the first linear combination calculated using a further one of the two first partial weighting vectors deviating from a calculated value of the second linear combination calculated using a further one of the two partial weighting vectors.

11. The device as claimed in claim 1, wherein:
the transformation network comprises one or more split transformation network components, and
the subset of the multiple input signals and the subset of the multiple output signals comprise the multiple input signals and the multiple output signals of a one of the one or more split transformation network components; or
the subset of the multiple input signals and the subset of the multiple output signals comprise all input signals and all output signals of the transformation network.

12. The device as claimed in claim 2, wherein each n-th of the first weights or each n-th of the second weights are specified with n>=2 by a predefined weighting factor.

13. The device as claimed in claim 1, wherein the error detection device is implemented in hardware; or
wherein the error detection device is implemented as a software component that is executed on a calculation unit of the device for encryption, the transformation network being implemented via execution of the calculation unit.

14. A non-transitory computer readable medium having instructions stored thereon that, when executed by one or more processors:
implement a transformation network having at least two stages of butterfly operations,
wherein the transformation network is configured to carry out a discrete Fourier transform over rings of multiple input signals to obtain multiple output signals; and
implement an error detection device to obtain at least one subset of the multiple input signals and at least one subset of the multiple output signals of the transformation network, and to carry out an error analysis,
wherein the error analysis is based on a comparison of a first linear combination of the subset of the multiple input signals to a second linear combination of the subset of the multiple output signals.

15. A method for encryption, comprising:
executing, via a transformation network having two stages of butterfly operations, a discrete Fourier transform over rings of multiple input signals to obtain multiple output signals;
obtaining at least one subset of the multiple input signals and at least one subset of the multiple output signals of the transformation network, and
performing an error analysis based on a comparison of a first linear combination of the subset of the multiple input signals to a second linear combination of the subset of the multiple output signals.

16. A device for determining first weights and second weights as a function of a transformation network having at least two stages of butterfly operations and being configured to perform a discrete Fourier transform over rings of multiple input signals to obtain at least multiple output signals,
wherein the device is configured to, using the first weights, calculate a first linear combination of the subset of the multiple input signals,
wherein the device is configured to, using the second weights, calculate a second linear combination of the subset of the multiple output signals, and
wherein the device is configured to determine the first and second weights such that a calculated value of the first linear combination equals a calculated value of the second linear combination when the discrete Fourier transform over rings of the multiple input signals has been performed without error.

17. The device as claimed in claim 16, wherein the first weights and the second weights depend on the transformation network or are determined depending on the transformation network.

18. The device as claimed in claim 17, wherein:
the first weights are defined by a first weighting vector a,
the second weights are defined by a second weighting vector b,
the first weighting vector a and the second weighting vector b are determined on the basis of the formula b=a·A, and
A represents a matrix that describes a behavior or an inverse behavior of the transformation network.

19. The device as claimed in claim 17, wherein:
the first weights and second weights are determined that satisfy the following inequations:
$${S}_{\frac{N}{{2}^{l}} {m}_{2} + {n}_{2}}^{l} ( a ) = {\sum }_{{m}_{1} = 0}^{\frac{N}{{2}^{l}} - 1} {ω}_{2 N}^{( 2 ( {2}^{l} {m}_{1} + {m}_{2} ) + 1 ) {n}_{2}} {a}_{{2}^{l} {m}_{1} + {m}_{2}} \neq 0$$
$$0 \leq l \leq {log}_{2} ( N ) ,$$
$$0 \leq {n}_{2} \leq {2}^{l} - 1 ,$$
$$0 \leq {m}_{2} \leq \frac{N}{{2}^{l}} - 1 ,$$
N indicates the dimension of the transformation network (100),
l=0, . . . , log₂ N, for each stage, and
m₂∈{0, . . . , 2^{l}−1} and
$${n}_{2} ∈ \{ 0 , ... , \frac{N}{{2}^{l}} - 1 \} .$$

20. The device as claimed in claim 17, wherein the first weights are defined by two first partial weighting vectors and the second weights are defined by two second partial weighting vectors.

21. The device as claimed in claim 20, wherein:
the two first partial weighting vectors and the two second partial weighting vectors are determined that satisfy the following inequations:
$${S}_{\frac{N}{{2}^{l}} {m}_{2} + {n}_{2}}^{l} ( {a}^{( 1 )} ) \neq 0$$
$${S}_{\frac{N}{{2}^{l}} 2 + {n}_{2}}^{l} ( {a}^{( 2 )} ) \neq 0$$
$${S}_{\frac{N}{{2}^{l}} {m}_{2} + {n}_{2}}^{l} ( {a}^{( ( 2 )} ) {S}_{\frac{N}{{2}^{\tilde{l}}} {\tilde{m}}_{2} + {\tilde{n}}_{2}} ( {a}^{( 1 )} ) - {S}_{\frac{N}{{2}^{l}} {m}_{2} + {n}_{2}}^{l} ( {a}^{( 1 )} ) {S}_{\frac{N}{2} {\tilde{l}}_{\tilde{l}} {\tilde{m}}_{2} + {\tilde{n}}_{2}} ( {a}^{( 2 )} ) \neq 0 ,$$
$$0 \leq l , \tilde{l} \leq {log}_{2} ( N ) ,$$
$$0 \leq {n}_{2} , {\tilde{n}}_{2} \leq {2}^{l} - 1 ,$$
$$0 \leq {m}_{2} , {\tilde{m}}_{2} \leq \frac{N}{{2}^{l}} - 1$$
a triple l, n₂ and m2 is not equal to a triple \tilde{l}, ñ₂ and \tilde{m}₂,
N indicates the dimension of the transformation network,
l and \tilde{l}=0, . . . , log₂ N for each stage, and
\tilde{m}₂ and m₂∈{0, . . . , 2^{l}−1} and ñ₂ and
$${n}_{2} ∈ \{ 0 , ... , \frac{N}{{2}^{l}} - 1 \} .$$

22. A method for determining first and second weights as a function of a transformation network, comprising:
performing, via the transformation network using at least two stages of butterfly operations, a discrete Fourier transform over rings of multiple input signals to obtain at least multiple output signals;
calculating, using the first weights, a first linear combination of the subset of the multiple input signals; and
calculating, using the second weights, a second linear combination of the subset of the multiple output signals,
wherein the first and second weights are determined such that a calculated value of the first linear combination equals a calculated value of the second linear combination when the discrete Fourier transform over rings of the multiple input signals has been performed without error.
